(19) United States
(12) Patent Application Publication
(10) Pub. No.: US 2014/0042105 A1
(43) Pub. Date: Feb. 13, 2014

(54) METHOD AND APPARATUS FOR PEROXONE ADVANCED OXIDATION IN WATER TREATMENT

(71) Applicant: Stephen R. McAdams, San Ramon, CA (US)

(72) Inventor: Stephen R. McAdams, San Ramon, CA (US)

(21) Appl. No.: 13/965,088

(22) Filed: Aug. 12, 2013

Related U.S. Application Data
(60) Provisional application No. 61/682,605, filed on Aug. 13, 2012.

(51) Int. Cl. C02F 1/72; C02F 1/78

(52) U.S. Cl. CPC C02F 1/722; C02F 1/78
USPC 210/759; 210/199

(57) ABSTRACT

A method of water treatment include mixing a hydrogen peroxide solution into a flow of water and subsequently mixing and dissolving ozone into the flow of water. The hydrogen peroxide solution may be conditioned with a water-soluble hydroxide salt. After the mixing and dissolving of the ozone into the flow of water, at least a portion of the hydrogen peroxide solution dissociates into hydroperoxide ions at a dissociation rate, the hydroperoxide ions react with the ozone to form hydroxyl radicals, and the hydroxyl radicals react with organic contaminants in the flow of water to remove the organic contaminants. The flow of water is then directed into a contact basin to facilitate the further decay of ozone.

### RELATED APPLICATIONS

This patent application claims the benefit under 35 U.S.C. §119(e) of U.S. Provisional Application No. 61/682,605, filed Aug. 13, 2012, which is herein incorporated by reference.

### TECHNICAL FIELD

Embodiments of the present invention relate to the field of water treatment and, in particular, to a system and method for removing organic contaminants from potable water using a combination of ozone, hydrogen peroxide and hydroxide ions.

### BACKGROUND

Approximately 16% of the water utilities in the United States experience serious taste and odor problems, and they spend an average of about 4.5% of their total budget on taste and odor control. Taste and odor problems experienced at water treatment plants affect the public's perception of drinking water safety. Two compounds responsible for earthy and musty taste and odor in drinking water supplies are methylisoborneol (MIB) and Geosmin, both of which are organic contaminants.

There are over 4000 ozonation systems operating worldwide in water treatment plants (WTP) with more planned. Ozone (O₃) is used primarily for disinfection and for removal of taste and odor compounds. Other uses or benefits include removal of micro-contaminants, removal of natural organic matter (NOM) and for pretreatment in biologically active carbon (BAC) filtration. All of the above uses of ozone are based on either or both the decomposition of ozone to reactive intermediates or a residual molecular concentration of the ozone.

Ozone water treatment facilities are very expensive to install and operate. For many water treatment plants that use ozone, the amount of ozone that is used is on the order of 2-3 milligrams per liter (mg/L). This high level of ozone is used to ensure that treated potable water meets specifications regarding an allowed amount of organic contaminants. Any reduction in the amount of ozone that is used to achieve the specified results introduces a cost savings to the municipalities that run the water treatment plants.

### BRIEF DESCRIPTION OF THE DRAWINGS

The present invention is illustrated by way of example, and not by way of limitation, in the figures of the accompanying drawings.

FIG. 1 illustrates a flow diagram of one embodiment for a method of treating drinking water using a peroxone advanced water oxidation process (AOP).

FIG. 2 illustrates one embodiment of a portion of a water treatment plant.

FIG. 3 illustrates another embodiment of a portion of a water treatment plant.

FIG. 4 illustrates yet another embodiment of a portion of a water treatment plant.

FIG. 5A illustrates the ozone decomposition mechanism and catalytic effect by hydrogen peroxide in the peroxone AOP, in accordance with embodiments of the present invention.

FIG. 5B illustrates use of hydrogen peroxide and ozone for oxidation of trichloroethylene, in accordance with embodiments of the present invention.

FIG. 6A illustrates the effect of total organic carbon (TOC) on instantaneous ozone demand (IOD) and ozone decay for various river waters.

FIG. 6B illustrates ozone decay rates versus TOC for the various river waters.

FIG. 6C illustrates an ozone decay rate versus TOC in terms of ozone dose and IOD.

FIG. 7 illustrates the effect of ozone dose and hydrogen peroxide:ozone mole ratio on the ozone decay rate constant.

FIG. 8 illustrates the effect of temperature on the ozone decay rate constant.

FIG. 9 illustrates a peroxide rate velocity versus ozone dose.

FIG. 10 illustrates a rate constant temperature dependence.

FIG. 11 illustrates the effect of temperature on the hydrogen peroxide rate velocity intercept.

FIG. 12 illustrates the effect of side stream injection on an ozone residual.

FIG. 13 illustrates the effect of peroxide conditioning on an ozone residual.

FIG. 14 illustrates the effect of hydroxide ions on an ozone concentration.

FIG. 15 illustrates the effect of hydroxide ions on a MIB concentration.

FIG. 16 illustrates the effect of hydroxide ions on MIB concentration.

### DETAILED DESCRIPTION

Described herein is a method and apparatus for treating water to remove organic contaminants using a combination of ozone and hydrogen peroxide. Known as Peroxone chemistry, the co-addition of hydrogen peroxide with ozone in water treatment application significantly reduces the ozone dose for the destruction of organic contaminants, increases the rate of ozone decomposition and reduces ozone residual. Additionally, use of ozone may provide the benefits of enhanced taste and odor removal, micro-contaminant removal, cyanotoxin removal, and/or avoidance of some disinfection byproducts (DBPs) and disinfection capabilities.

In one embodiment, a flow of water is treated by first injecting and mixing a hydrogen peroxide solution into the flow of water and subsequently injecting, mixing and dissolving ozone into the flow of water. The hydrogen peroxide solution may be conditioned with a water-soluble hydroxide salt to facilitate a dissociation of the hydrogen peroxide solution into hydroperoxide ions. After the mixing and dissolving of the ozone into the flow of water, at least a portion of the hydrogen peroxide solution dissociates into hydroperoxide ions at a dissociation rate, the hydroperoxide ions react with the ozone to form hydroxyl radicals, and the hydroxyl radicals react with organic contaminants in the flow of water to remove the organic contaminants. The hydroxyl radicals may remove taste-and-odor organic contaminants such as Geosmin and 2-methyl isoborneol (2-MIB) from potable water, such as by oxidizing these organic contaminants.

Use of the hydrogen peroxide solution reduces a concentration of ozone that can be used to remove organic contaminants from the main flow of water. Hydrogen peroxide should first dissociate into the hydroperoxide ion in order to efficiently react with ozone. The amount of ozone that is used may be reduced by up 50% or more in some cases. Moreover, conditioning of the hydrogen peroxide solution may cause the amount of ozone that is used to be reduced even further. For example, the addition and mixing of hydroxide ions (e.g., in the form of a water-soluble hydroxide salt) with hydrogen peroxide significantly increases the rate of hydrogen peroxide dissociation at low temperatures and in short times. In some instances, straight hydrogen peroxide (or a solution of hydrogen peroxide and water) may not on its own cause the effectiveness of the ozone to increase. For example, at pH below 7.0 or temperatures below 20 degrees C., the ability of hydrogen peroxide may to improve the effectiveness of ozone is reduced. In such instances, conditioning the hydrogen peroxide solution causes it to again improve the effectiveness of the ozone.

In one embodiment, the hydrogen peroxide solution and the ozone are injected into a side flow of water that has been diverted from a main flow of water. After the hydrogen peroxide solution and ozone are mixed into the side flow of water, the side flow of water may be re-injected and mixed into the main flow of water. Alternatively, the hydrogen peroxide solution and ozone may be injected and mixed directly into the main flow of water. In either case, the main flow of water is then directed into a contact basin.

Note that embodiments are described herein with regards to treatment of potable drinking water. However, the same methods and apparatuses described herein with reference to treatment of potable water may also be used for industrial water treatment and/or for wastewater treatment.

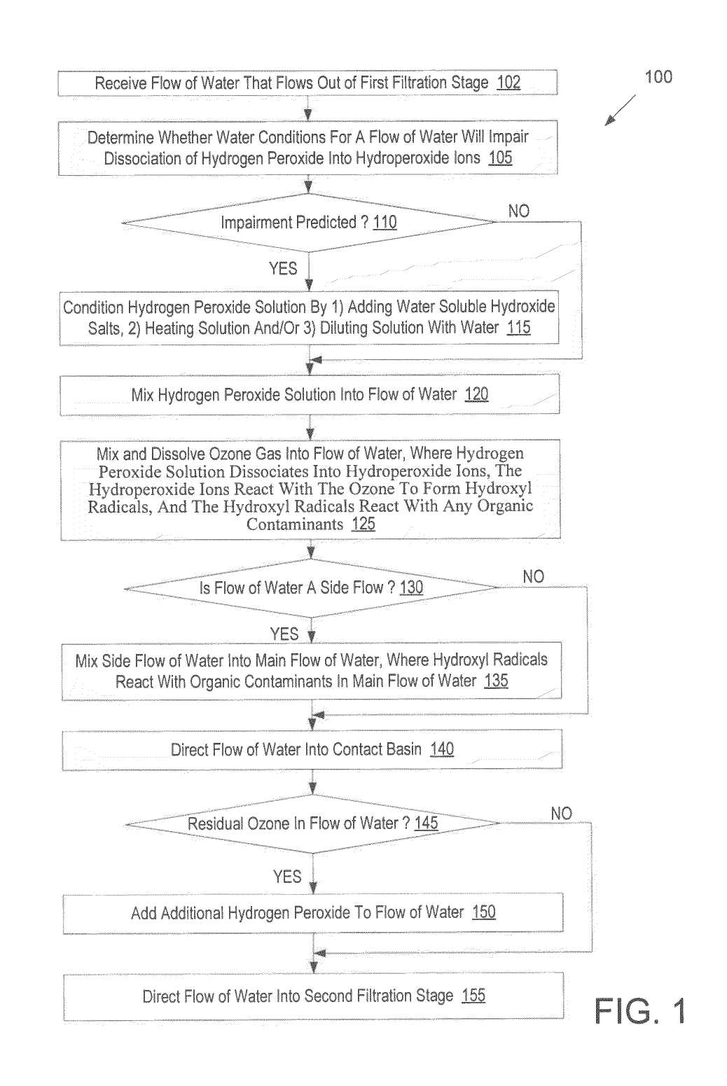

FIG. 1 illustrates a flow diagram for a method 100 of treating drinking water using a peroxone advanced water treatment process. Method 100 may be performed by a water treatment plant or facility that has been configured to perform the method in some embodiments.

At block 102 of method 100, a flow of water is output from a first filtration stage of a water treatment plant (WTP). The first filtration stage may be a gravity-type, packed bed filter, which may include granulated activated carbon (GAC), granulated anthracite, sand, and/or a membrane. Filters that use membranes may also be pressure type filters (i.e. pumped up to a higher pressure rather than using a gravity flow).

At block 105, a determination is made as to whether water conditions for the flow of water will impair dissociation of hydrogen peroxide into hydroperoxide ions. This determination may be made based on measurements of a temperature of the flow of water and/or a pH of the flow of water. For example, dissociation of hydrogen peroxide into hydroperoxide ions may be optimal at a pH of 8 and a temperature of 25° C. or higher. Sensors in water pipes may detect the pH and/or temperature. The sensor measurements may be reported to a plant operator, who may make the determination. Alternatively, the determination may be automated. For example, a programmable logic controller (PLC) may be configured to receive the temperature and/or pH measurements, and to make a determination as the dissociation rate of hydrogen peroxide under the present conditions.

Ozone decomposition is dependent on many factors including temperature, a concern during winter months when water-supply temperatures can approach freezing in northern latitudes. The half-life of ozone in pure water at pH 7 is a very strong function of temperature. Between 25° C. and 0° C., the ozone half-life increases by a factor of 6, and conversely, the decay reaction rate decreases by the same factor. Ozone decomposition (or half-life) is also a strong function of pH and water chemistry, both of which may vary significantly with source or pre-treatment.

In the Peroxone process, hydrogen peroxide (H₂O₂) can be used with ozone in advanced oxidation processes (AOP) to enhance the beneficial use of ozone by accelerating the ozone decomposition and increasing the formation of highly-oxidative hydroxyl radical (OH.). In the absence of H₂O₂, ozone decomposition typically begins with reaction with hydroxide ion (OH⁻).

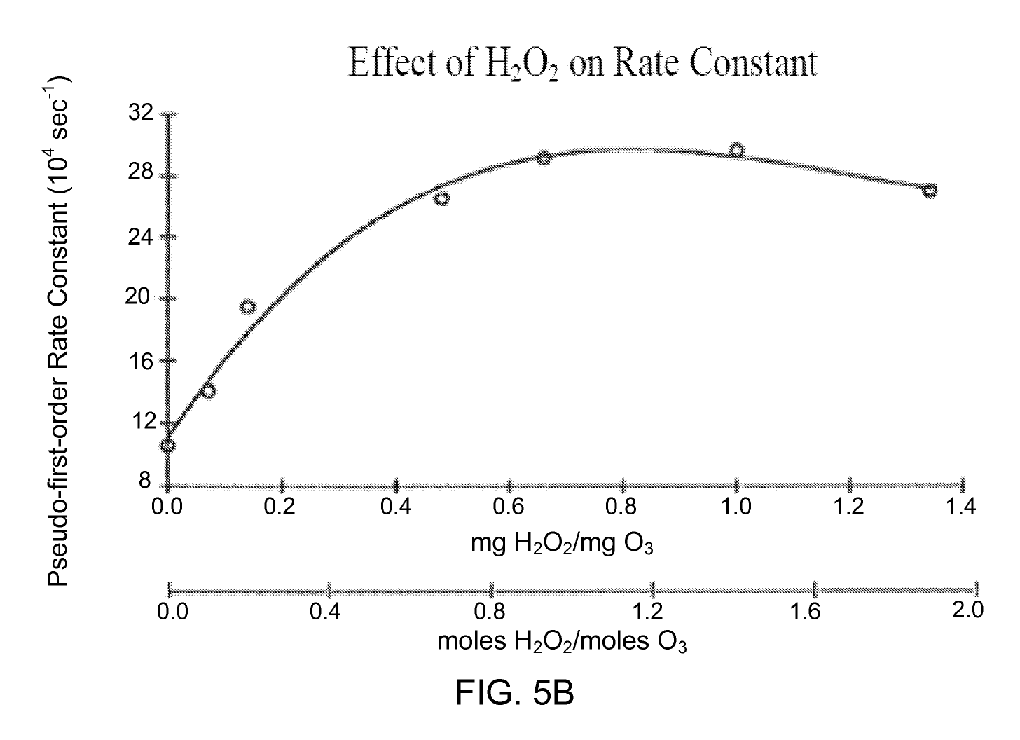

FIG. 5A illustrates the ozone decomposition mechanism and catalytic effect by H₂O₂ in the Peroxone AOP. As shown, ozone decomposes into many very reactive species, some of which may be short lived. For example, some species may have a life that is on the order of a millionth of a second. In the absence of H₂O₂, ozone decomposition typically begins with the reaction with hydroxide ions (OH⁻). The hydroxyl radical (OH.) is one species that ozone eventually decomposes into. However, there are numerous other intermediate species that ozone first decomposes into before decomposing into OH., which reduces the amount of available OH.. The hydroxyl radical (OH.) is the most effective of the known species for treating water contaminated with organic compounds. The addition of hydrogen peroxide H₂O₂ to the ozone short circuits the loop of intermediary species, and causes preponderance of the ozone to decompose directly into hydroxyl radicals.

Peroxide dissociation is a strong function of pH. Un-dissociated H₂O₂ reacts very slowly with ozone. However, the conjugate base to hydrogen peroxide, the hydroperoxide ion (HO₂⁻), reacts rapidly with ozone in a two-step reaction forming OH. radicals. A reaction rate constant for HO₂⁻+O₃ is around 5.5×10⁶/mol/sec., as opposed to a reaction rate constant of 7.0×10¹/mol/sec for OH⁻+O₃. Accordingly, the reaction rate constant for HO₂⁻+O₃ is around 5 orders of magnitude greater. Thus, for Peroxone, the presence of hydroxide ions or higher pH increases both ozone decomposition and OH. radical formation. Further, Ozone mass transfer from gas to dissolution liquid is enhanced by faster chemical reaction as the driving force for mass transfer is increased by lowering the concentration of dissolved ozone in the water. However, as shown in FIG. 5B, which shows use of H₂O₂ and ozone for oxidation of trichloroethylene (TCE), in some cases H₂O₂ can also act as an OH. radical scavenger at high concentration (e.g., above a molar ratio of around 1.2 H₂O₂ to O₃), slowing the reaction rate.

Referring back to FIG. 1, at block 110, it is determined whether impairment of the dissociation for hydrogen peroxide into hydroperoxide ions is predicted (e.g., by an operator or by a processing device such as a PLC). If impairment is predicted, the method continues to block 115. If impairment is not predicted, the method proceeds to block 120.

At block 115, a hydrogen peroxide solution is conditioned by adding water soluble hydroxide salts, by heating the solution and/or by diluting the solution with water. The dissociation of hydrogen peroxide into hydroperoxide ions is a function of both temperature and pH. By increasing the pH of the hydrogen peroxide solution via the addition of hydroxide salts, the dissolution of the hydrogen peroxide may be facilitated. This may be especially useful for treatment of cold water (e.g., that is between 0° C. and 25° C.). An amount of hydroxide salts may be used that will affect the pH of a side stream of water that is 2-5% of a main stream of water, but that will not change a pH of the main stream of water. Examples of water-soluble hydroxide salts that may be used include calcium hydroxide, potassium hydroxide and sodium hydroxide. The dose of hydroxide salts that may be used are 0.1-0.4 mg/L in one embodiment. This dosage is the dosage for a main flow of water. The concentration of hydroxide salts when added to a side flow of 2-5% of a main flow of water may be 10-40 times the above dose, but will be diluted back to the above described dose when the side flow of water is mixed back into the main flow of water. Enough hydroxide salt may be added to the side stream of water to bring its pH up to approximately 8. In some cases this will use a dose of around 1-40 mg/L of hydroxide salts into the side stream of water (which will dilute down to 0.1-0.4 mg/L in the main stream).

At block 120, the hydrogen peroxide solution is mixed into the flow of water. At block 125, ozone gas is injected and mixed into the flow of water. As a result of the injection and mixing, a portion of the ozone gas dissolves into the flow of water.

Two compounds responsible for earthy and musty taste and odor in drinking water supplies are methylisoborneol (MIB) and Geosmin. Hydroxyl radicals may account for a greater percentage of MIB or Geosmin oxidation relative to molecular ozone. For example, hydroxyl radicals may account for over 85% of MIB oxidation relative to molecular ozone. MIB-ozone reaction rate constants of k_{O3,MIB}<1M⁻¹s⁻¹ have been reported compared to MIB-OH. reaction rate constants of k_{OH.,MIB}>8×10⁹M⁻¹s⁻¹. Moreover, oxidation is independent of the initial MIB concentration and increases with ozone dose, pH, temperature and H₂O₂. There may be a doubling of MIB removal efficiency at 1-3 mg/L ozone dose and 0.5 mass ratio H₂O₂/O₃ versus ozone alone. Additionally, H₂O₂ addition at a ratio of as low as 0.2 w/w may have a significant impact on MIB and Geosmin destruction, and contact time may not have a significant impact. Further, 90% destruction of MIB would use >4.0 mg/L of ozone, as compared to approximately 2.0 mg/L of ozone with peroxide. 4-6 mg/L ozone with 1-2 mg/L hydrogen peroxide may be as effective as 8-10 mg/L ozone alone for up to 1,000 nanograms/liter (ng/L) Geosmin in influent surface water. Thus, Peroxone can reduce ozone consumption as much as 50%.

The addition of ozone to water results in an initial fast reaction typically called instantaneous ozone demand (IOD) and a slower pseudo first-order decay. IOD is a function of factors including ozone dose, temperature, pH, alkalinity and organic content. Empirical determination of IOD may be useful prior to design of ozone injection systems.

In present WTP practice, ozone is commonly injected in high-pressure, low-flow side-stream configurations resulting in high doses near the ozone solubility limit, 20-40 milligrams/Liter (mg/L). In such processes, IOD will be high and may either reduce the overall efficiency of the ozonation process or increase operating costs.

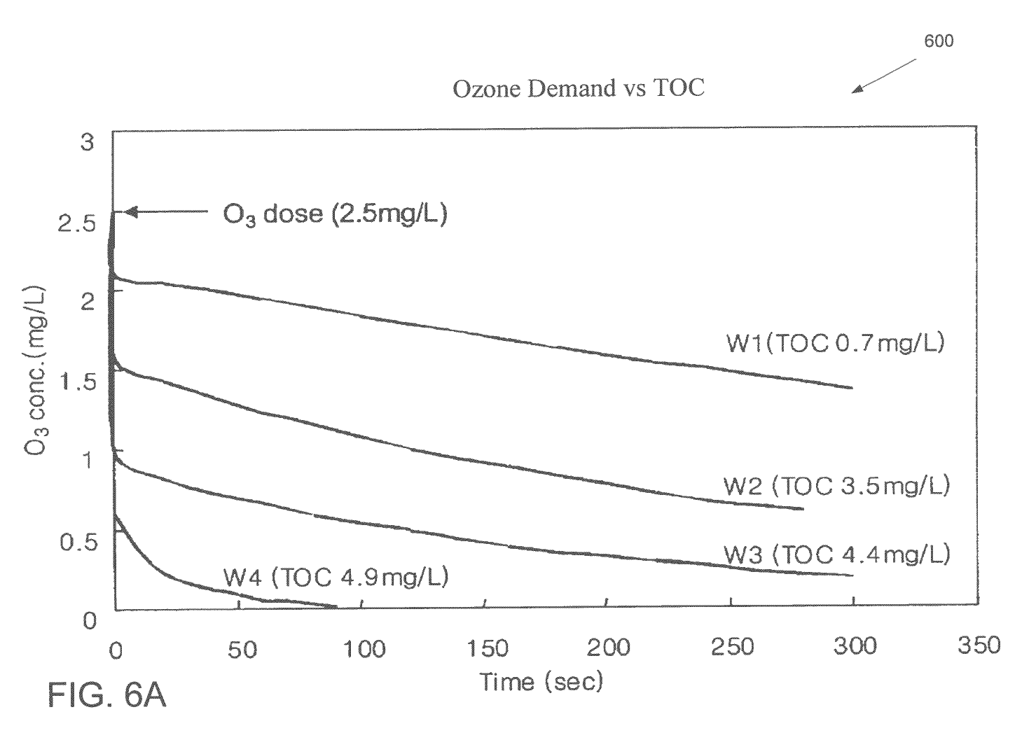

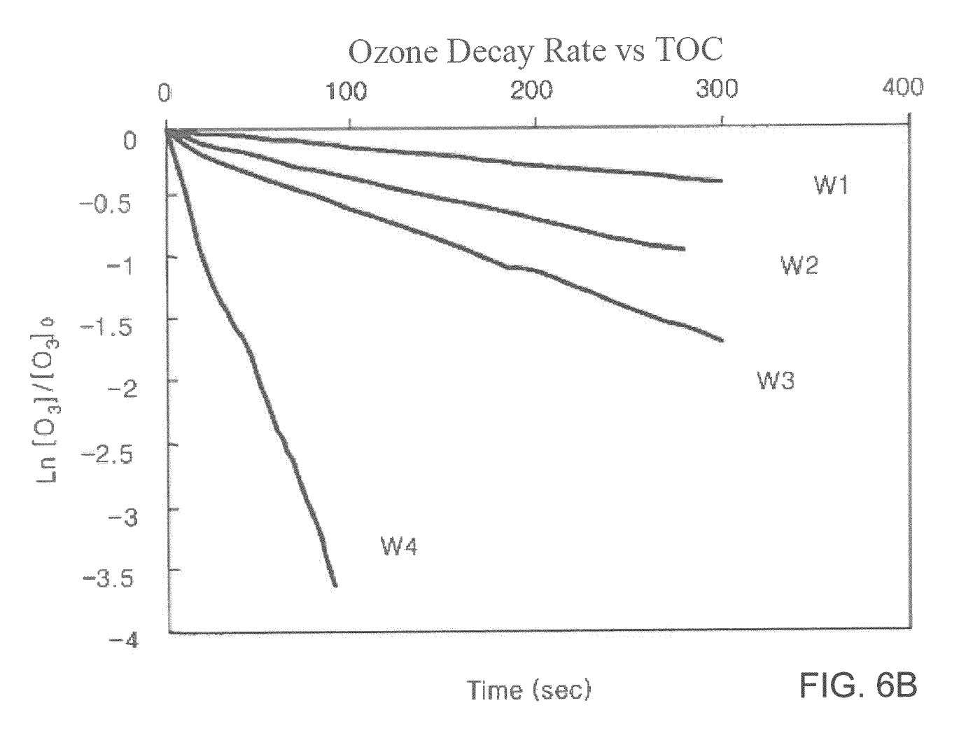

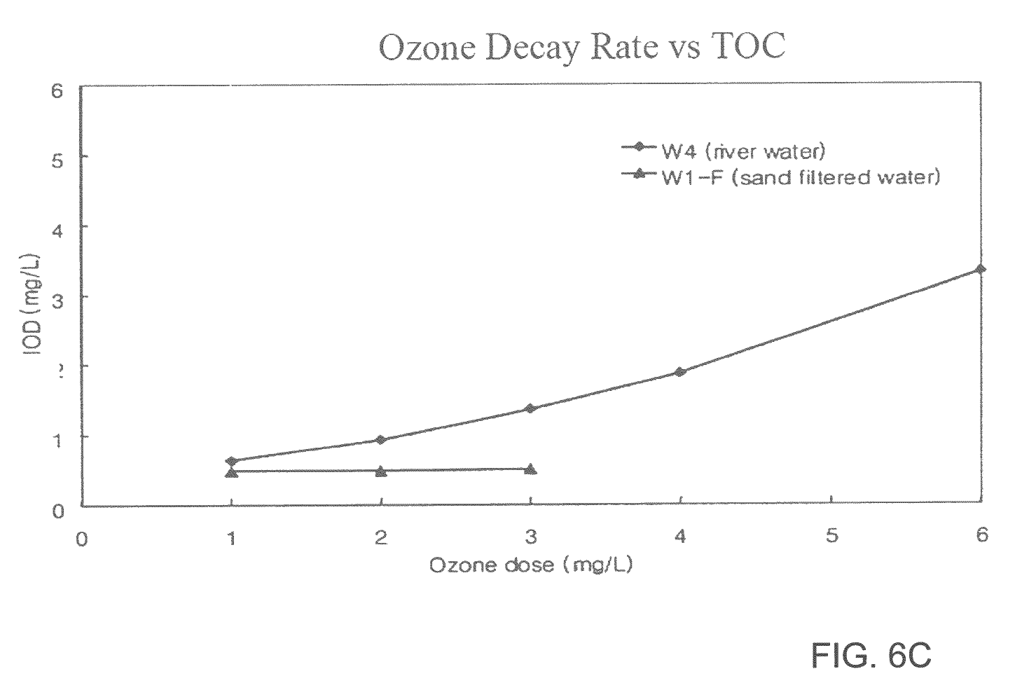

In pure water, IOD is very small or non-existent. FIG. 6A illustrates the effect of total organic carbon (TOC) on both IOD and ozone decay for various raw river waters (W1, W2, W3 and W4) in terms of ozone demand versus TOC. FIG. 6B illustrates an ozone decay rate versus TOC for the same raw river waters W1, W2, W3 and W4. FIG. 6C illustrates an ozone decay rate vs. TOC for raw river waters W1 and W4 in terms of ozone dose and IOD. As shown in FIGS. 6A-6C, IOD may be about 40% of the TOC concentration, with a relationship that is not strictly linear.

For river waters, while IOD typically increases with ozone dose, it may be lower and remain constant for sand-filtered water. High IOD may be attributed to the presence of a significant amount of natural organic matter (NOM) in unfiltered river water that is significantly reduced in sand filtration. The relationship between coagulant dose and turbidity in sand-filtered water reveals a relationship between turbidity and TOC which may be attributed to NOM. IOD may be mainly due to the reaction of ozone with NOM in some cases, which may constitute approximately 25-30% w/w of the dissolved organic carbon (DOC). Similarly, IOD may be responsible for the consumption of more than 40% of the applied ozone.

IOD results primarily from the direct (molecular) ozone reaction with dissolved organics, not from the OH. radical reaction. Thus, it is advantageous to use highly-filtered water in the side stream to reduce the organic content of water (TOC, NOM, DOC) to reduce IOD and ozone consumption prior to the creation of OH. radicals. Where ozone residual and contact time are important, IOD can be an undesired side reaction resulting in higher ozone consumption and operating costs. Accordingly, in some embodiments, the stream of water that the ozone and hydrogen peroxide are added to is a side flow of water that has been diverted from a main flow of water. The side flow of water may be diverted from the main flow of water from an upstream location, or pumped from a downstream location. If the side flow of water is pumped from a downstream location, it may be pumped from an output of a later filtration stage (e.g., from the output of a granulated activated carbon (GAC) filter, and may have a minimal amount of NOM, reducing an amount of IOD by up to 50%.

One concern associated with ozone application is that bromide ions (Br⁻) in water, as is typical of coastal surface waters, can be oxidized into bromate ions (BrO₃⁻) and other harmful bromated organic disinfection by-products (DBP). Peroxone does not form the typical DBPs including total halogenated methanes (THM) or haloacetic acids (HAA). If bromide ions are present, bromate (BrO₃⁻) is formed via the chain reaction with ozone:

Br⁻→O₂+BrO₋→O₂+BrO₂⁻→O₂+BrO₃⁻

However, with the addition of H₂O₂, the chain reaction is interrupted when the concentration of ozone is minimized by conversion to hydroxyl radicals, and the hypobromite ion (BrO⁻) is converted back to bromide by hydrogen peroxide:

BrO⁻+H₂O₂→Br⁻+H₂O+O₂

Referring again to FIG. 1, at block 130 of method 100 if the flow of water to which the ozone and hydroxide have been added is a side flow, the method continues to block 135. If the flow of water to which the ozone and hydroxide have been added is a main flow, the method proceeds to block 140.

At block 135, the side flow of water is mixed back into the main flow of water in a reactor. This causes the hydroxyl radicals from the side flow of water to react with organic contaminants in the main flow of water.

At block 140, the main flow of water is directed into a contact basin. The contact basin may be a large tank that holds the water for a time (e.g., anywhere from a few minutes to an hour, and typically for about 15-30 minutes). Ozone naturally dissociates, and the purpose of the contact basin may be to slow down the flow of water to enable any residual ozone in the flow to naturally dissipate. Contact basins represent a large land requirement and capital investment. Thus, techniques for reducing the amount of residual ozone in the flow of water prior to insertion into the contact basins may provide a financial savings to WTPs.

Following ozonation, any residual ozone should be reduced or eliminated to prevent exposure to personnel and interference with downstream equipment, processes and water quality. This is typically done with retention time (e.g., by use of the contact basin), chemical additives such as calcium thiosulfate, sulfur dioxide, sodium thiosulfate and sodium meta-bisulfate or carbon-based filters such as granulated activated carbon (GAC) or anthracite. Additives leave a chemical residual which may have a negative effect on water quality, and carbon filters require additional space and capital cost and which may foul, blind, deactivate or experience attrition over time resulting in discoloration of the water. Hydrogen peroxide can accelerate the decay of ozone and facilitate quenching of any ozone residual. In one embodiment, an ozone residual concentration of less than 0.05 mg/L at the outlet of a contact basin (also referred to as a contactor) is designed for.

In most applications, ozone decomposition can be characterized by a pseudo, first-order reaction written as:

dC/dt=−k′*C (1)

where:
C=ozone concentration, moles/liter
k′=(pseudo) decomposition rate constant, sec⁻¹
t=time, sec

The rate constant, k′, incorporates the effects of pH or hydroxide ion concentration, hydrogen peroxide concentration, temperature and all other factors affecting overall water chemistry. Rearranging Eqn. 1 and integrating:

ln(C/C₀)=−k′(t−t₀) (2)

or

C=C₀*exp(−k′t) (3)

where:
C₀=initial ozone concentration, [O₃]₀
t₀≡0, start time, sec

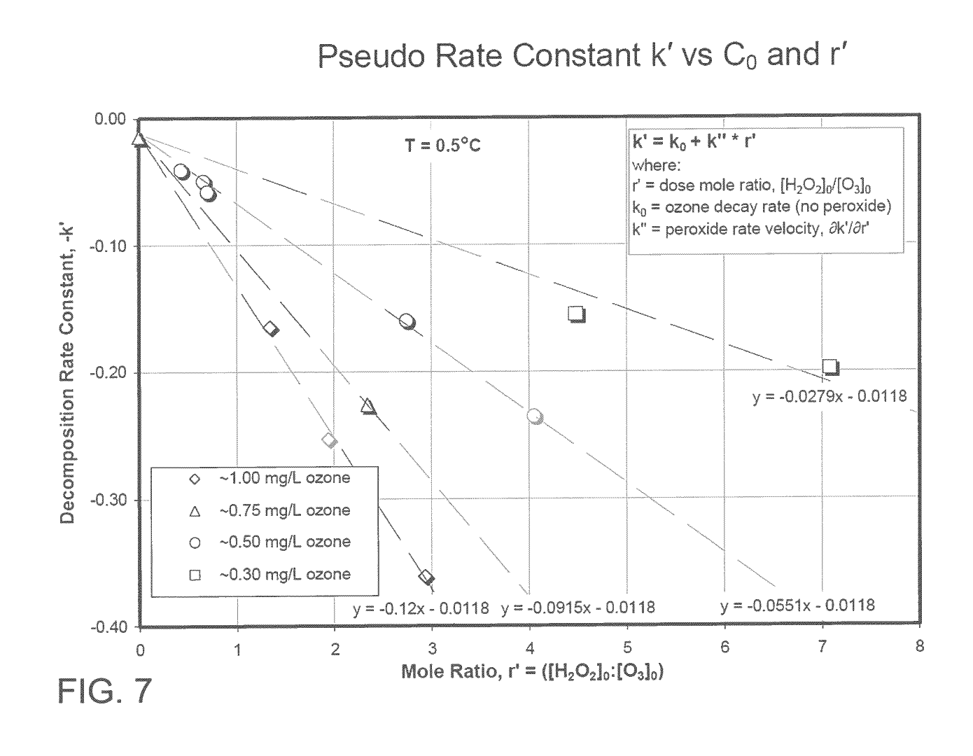

When the log of ozone concentration is measured and plotted versus time, the slope of the resulting curve or line is the pseudo reaction rage constant −k′. Pilot testing has shown k′ can be empirically expressed as a function of the simple (no hydrogen peroxide) ozone decay rate constant and a linear function of hydrogen peroxide mole ratio as shown in FIG. 7, which illustrates the pseudo rate constant as plotted versus the dose mole ratio, r′ and C₀. Each line represents a collection of rate constants at equal ozone doses but different hydrogen peroxide doses or mole ratio, r′. The lines increase in slope as the ozone dose increases, and they all originate from the standard decay rate constant, k₀, which is dependent on temperature but independent of ozone concentration and H₂O₂ concentration.

The rate constant k′ may be computed as follows:

k′=k₀+k″r′ (4)

where:
k₀=ozone half-life rate constant when [H₂O₂]₀=0 or r′=0
k″=“peroxide rate velocity” as defined herein
[H₂O₂]₀=initial concentration or dose of hydrogen peroxide, moles/liter
r′=[H₂O₂]₀/[O₃]₀

When the pseudo rate constant k′ is measured and plotted versus dose mole ratio at constant ozone dose, the slope of the resulting curve or line is k″, a measure of the effect of hydrogen peroxide or the rate (velocity) at which the ozone-decomposition rate constant changes with the hydrogen peroxide-ozone molar dose ratio. The ozone half-life is a strong function of temperature.

The half-life rate constant may be expressed in terms of the Arrhenius equation:

k₀=A*exp(−E_{A}/RT) (5)

or

ln(k₀)=(1/T)(−E_{A}/R) (6)

where:
A=frequency constant
E_{A}=activation energy
R=ideal gas constant
T=absolute temperature, ° K

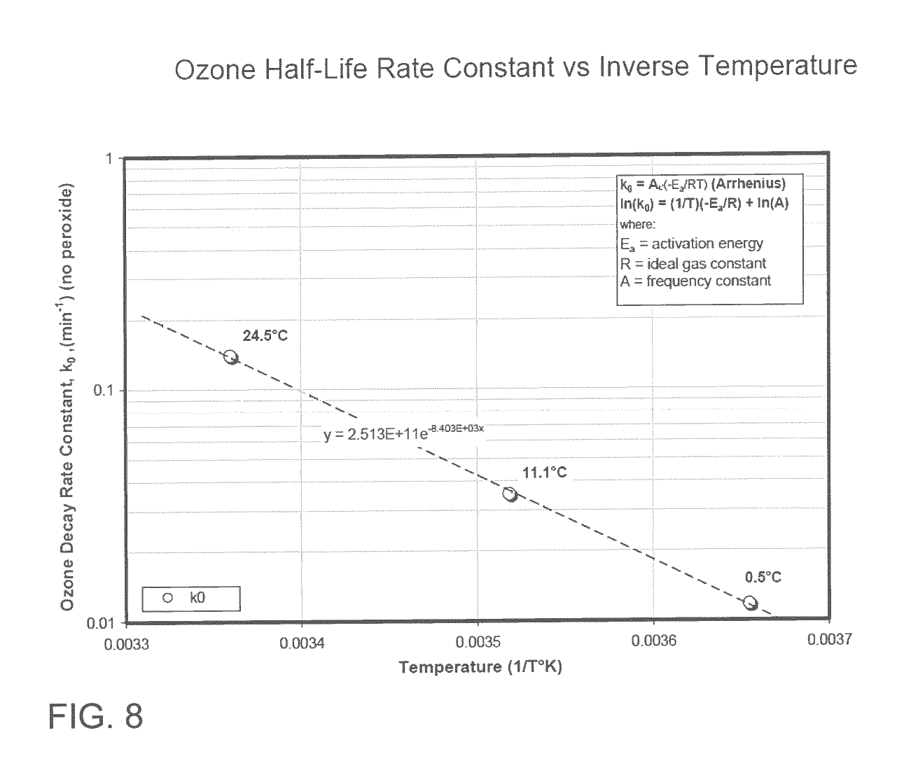

As shown in FIG. 8, values of standard decay rate constant were determined at each operating temperature and plotted. When the log rate constant is plotted versus the inverse of absolute temperature (1/T° K), the resulting line will be linear and the slope constant as pilot testing has shown in FIG. 8, which illustrates the ozone half-life rate constant verses an inverse of temperature. This linear relationship can be represented by the Arrhenius equation (equation 6). The value of k₀ estimated by this method is specific to the environment at which the experiments are run.

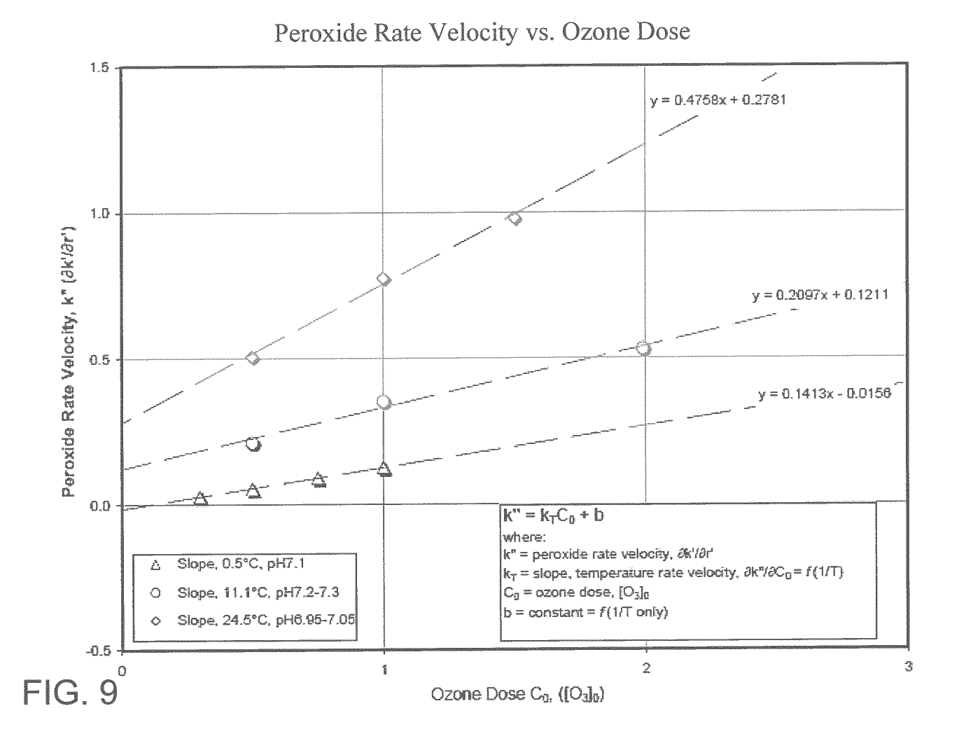

The peroxide rate velocity will have a dependence on temperature as well as dependence on the dose mole ratio which includes both initial ozone and hydrogen peroxide concentrations. The peroxide rate velocity will increase with ozone dose at constant dose mole ratio suggesting it is a function of initial ozone dose. Conversely, given the direct relationship of ozone and hydrogen peroxide as expressed by the dose mole ratio, the peroxide could also be expressed as a function of initial hydrogen peroxide dose. Since it was the intent of pilot testing to determine the appropriate hydrogen peroxide dose for any ozone dose, the peroxide rate velocity can be expressed as a temperature-dependent linear function of ozone dose as shown in FIGS. 9, 10 and 11.

FIG. 9 illustrates a peroxide rate velocity versus ozone dose. When the slope of each line in FIG. 7 is plotted against the corresponding ozone dose, the linear relationship between the peroxide rate velocity, k″, and the ozone dose is evident. This relationship represents, in effect, an acceleration in reaction rate with increasing peroxide concentration. The increasing slopes of these isotherms, k_{T}, further reveal a temperature dependence associated with the hydrogen peroxide reaction as shown in FIG. 9.

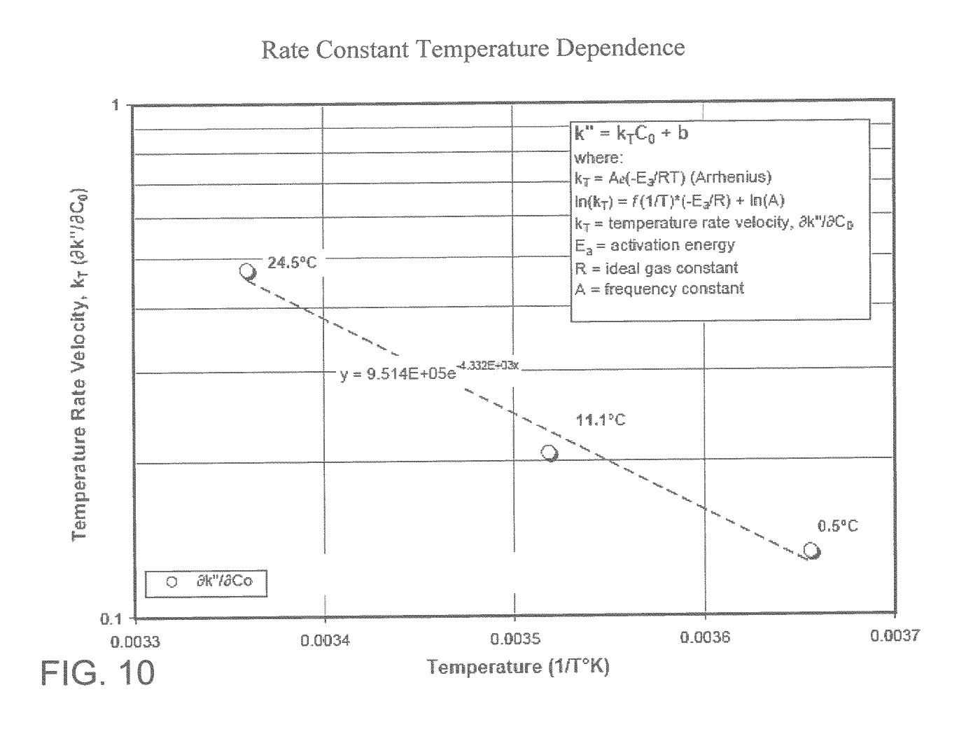

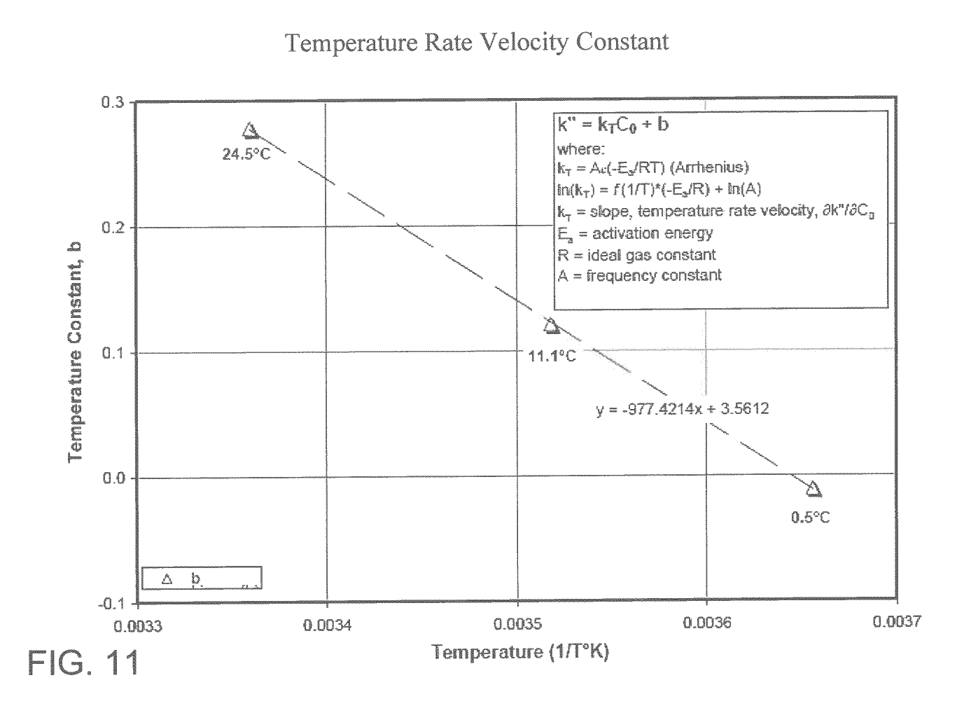

When the slope and intercept of each isotherm are plotted verses inverse absolute temperature, the temperature dependence is quantified as shown in FIGS. 10-11. FIG. 10 illustrates a rate constant temperature dependence based on temperature rate velocity versus temperature. FIG. 11 illustrates the temperature rate velocity constant in terms of the temperature constant, b, versus temperature.

The following equation shows that:

k″=∂k′/∂r′=ƒ(T,C₀)≈k_{T}*C₀+b (7)

where:
k_{T}≡“temperature rate velocity”, ∂k″/∂C₀=ƒ(T)
b=temperature dependent constant, =ƒ(T)

The temperature rate velocity is a reaction rate constant with no apparent concentration dependence and can be expressed in terms of the Arrhenius equation or a function of the inverse absolute temperature, 1/T. Analysis of ozone decomposition at different temperatures will yield insight and an approximation of the empirical temperature dependence of k_{T} and ozone reaction rates in the presence of hydrogen peroxide. With information for a specific water supply and conditions, the operator can design or set the appropriate conditions with a degree of reasonable certainty to use ozonation with hydrogen peroxide quenching or advanced oxidation for water treatment including taste and odor control or disinfection.

Pilot testing at three separate times and temperatures, permits complete empirical characterization of the pseudo, peroxide-catalyzed ozone decay rate constant using the following formula:

k′=k₀+(k_{T}*C₀+b)*r′ (8)

With the results of testing as illustrated in FIGS. 7-11, one can predict the decay rate of ozone in the presence of hydrogen peroxide at any temperature. These results are empirical. However, they and the proposed kinetic model represented in equations 1-7 represent a predictive capability that would be useful both in designing pre-ozonation systems and contactors as well as process control for both. It would also be useful in predicting and controlling operating costs by minimizing ozone use.

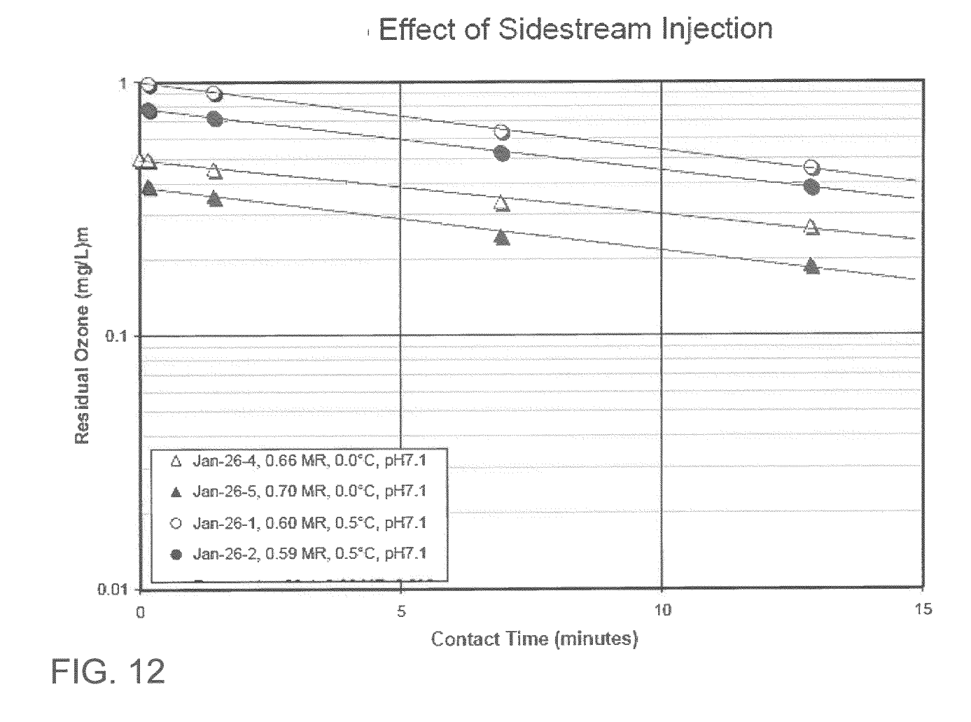

FIG. 12 shows the effect of side stream injection on residual ozone in terms of residual ozone verses contact time. In a side stream injection configuration, the local concentration of ozone in the side flow of water may be approximately 20 times greater than the applied dose. As a result, the initial fast consumption rate of ozone may be high and attributed to IOD.

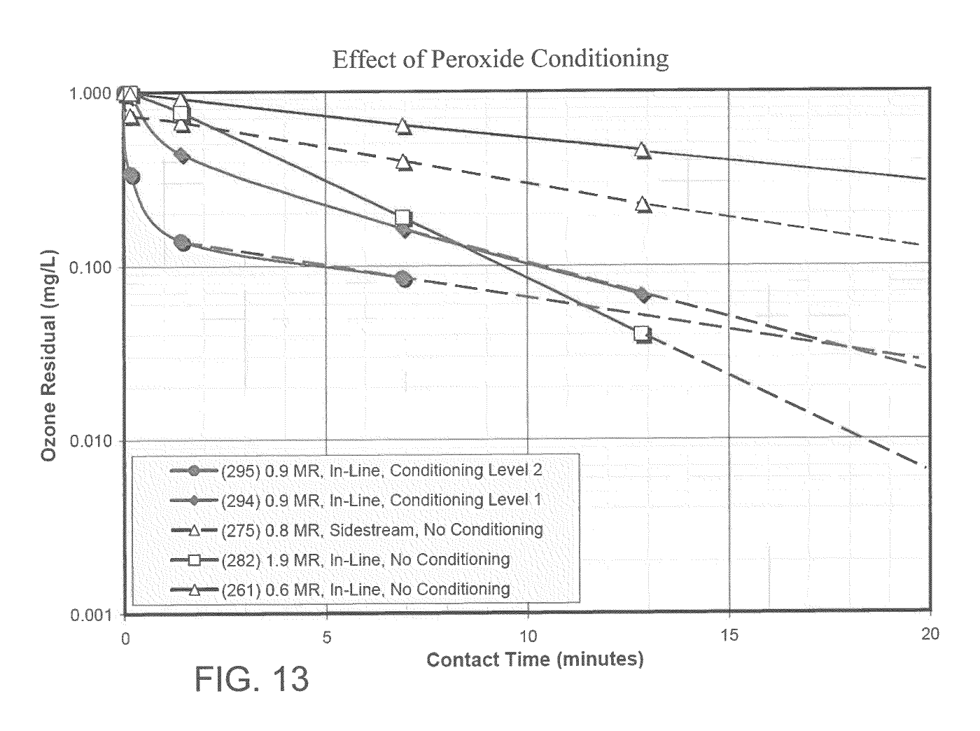

FIG. 13 illustrates the effect of peroxide conditioning on an ultimate ozone residual. As discussed previously, the hydrogen peroxide solution (reagent) can be conditioned by adjusting its concentration, temperature and pH to enhance Peroxone performance. Conditioning may have a major effect on the reactivity of hydrogen peroxide with ozone and negligible effect on water pH and temperature. Following the first few seconds of contact time, the ozone decomposition rate is similar to that for the initial dose but at a much lower residual ozone concentration, an effect similar to that attributed to NOM.

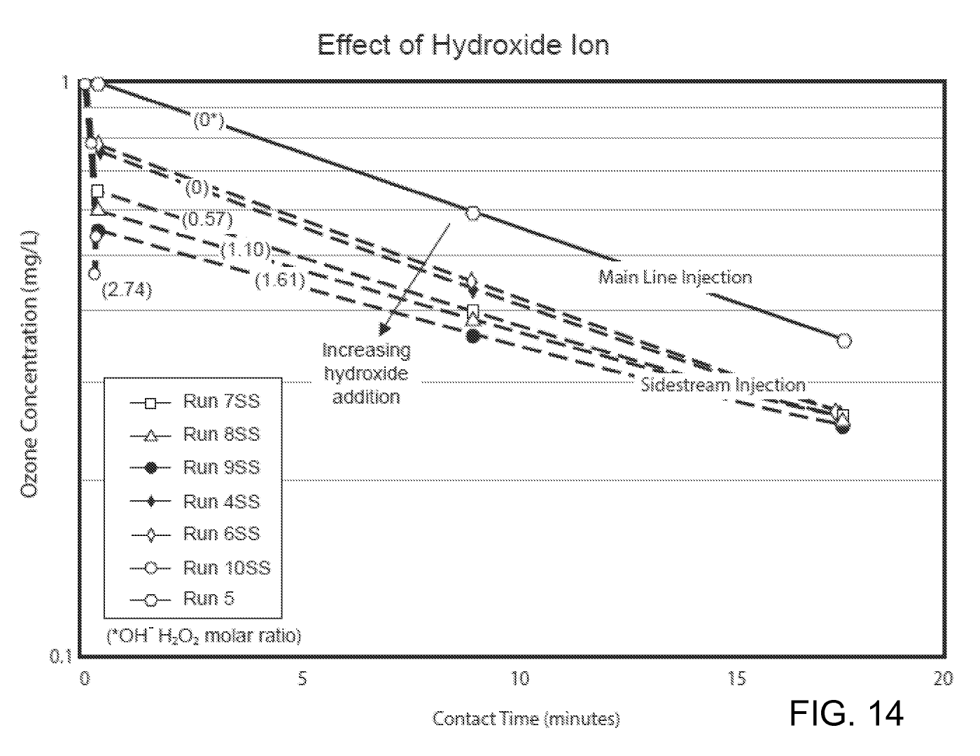

FIG. 14 illustrates the effect of hydroxide ions on ozone concentration. The hydroxide ion does not change effluent pH, being consumed by reaction. Additionally, any decrease in ozone concentration in the contactor may result in an increase in residual MIB concentration in some embodiments. Results show that AOP may result in MIB destruction approximately equivalent to twice the ozone-only dose in some embodiments.

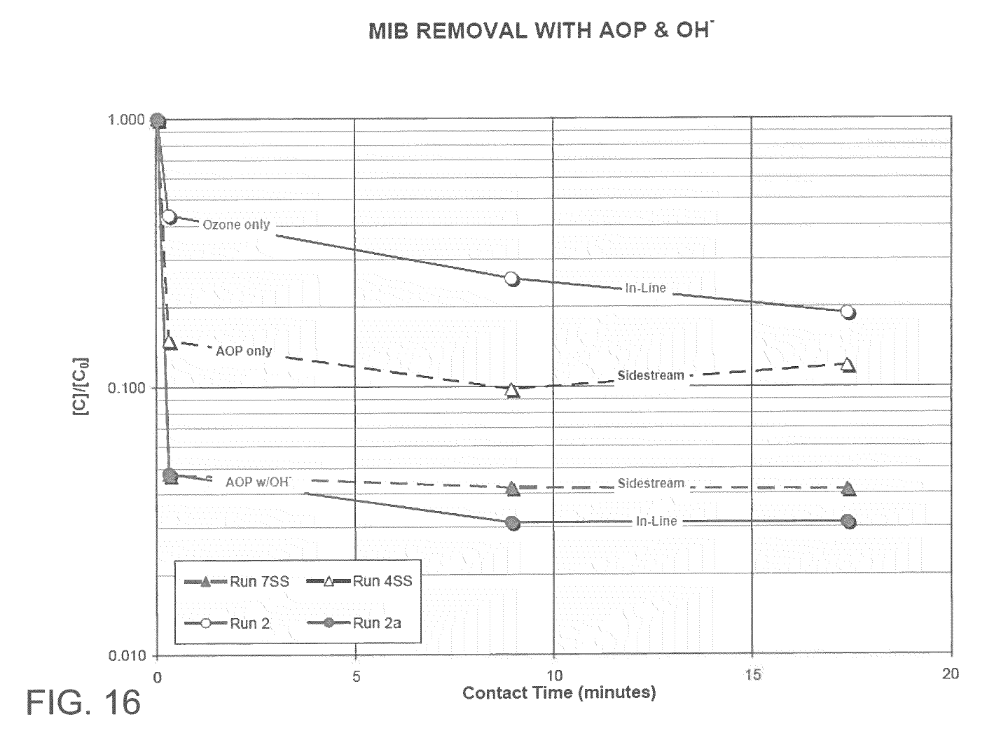

FIG. 16 illustrates the effect of hydroxide ions on MIB concentration. Results show that AOP may result in MIB destruction approximately equivalent to twice the ozone-only dose in some embodiments. Results also show that AOP with hydrogen peroxide that is conditioned with hydroxide ions may result in MIB destruction approximately equivalent to more than 4 times the ozone-only dose in some embodiments.

As shown in the figures and through testing, using peroxone will enhance both MIB destruction and ozone decay. Additionally, using peroxone, most MIB destruction occurs within the first 20 seconds. In one embodiment, an optimum ozone dose is <0.5 mg/L for MIB concentrations of up to 50 ng/L. In one embodiment, the optimum molar ratio of peroxide to ozone is between 0.35-0.7. Decay of ozone may be accelerated in the presence of hydrogen peroxide and is a strong function of the [H₂O₂]₀/[O₃]₀ molar ratio (MR). The empirical model shown in embodiments herein can predict residual ozone concentration and optimum hydrogen peroxide dose. How and where the hydrogen peroxide is added to the water in relation to the ozone can be important in achieving optimal decomposition rates.

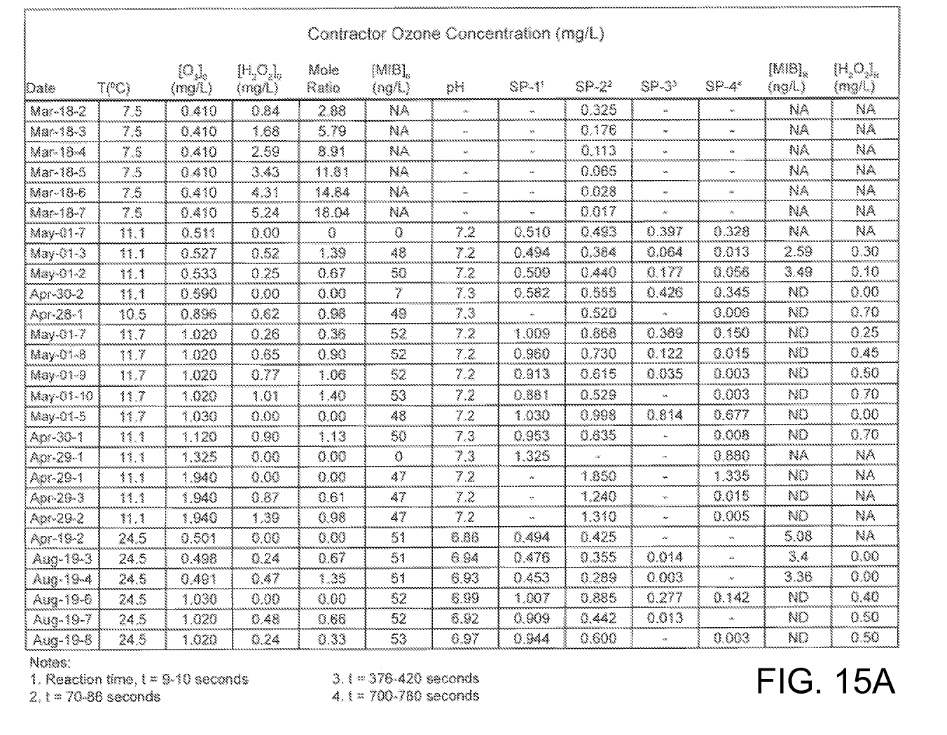

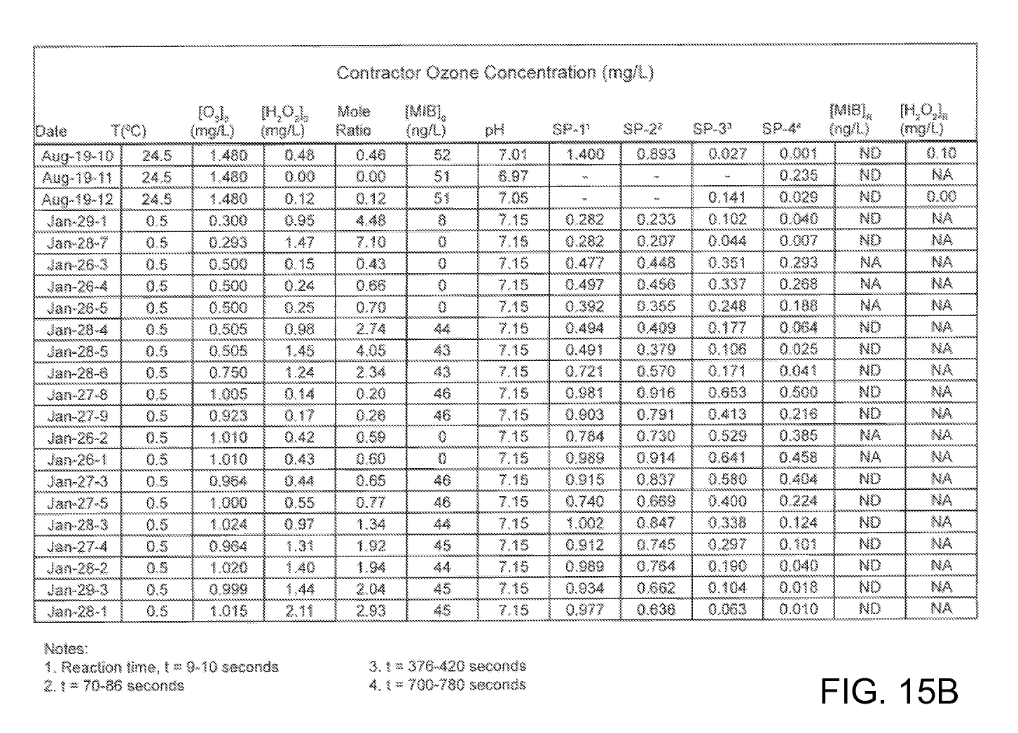

In embodiments of the present invention, ozone residual can be controlled at any desired level with the use of hydrogen peroxide, as shown in the table of FIG. 15. In the shown experimental results, at ozone doses of about 0.3 mg/L, up to 50 ng/L 2-MIB is reduced to <5 ng/L or non-detect (ND). Doses of ozone and hydrogen peroxide, as well as an appropriate conditioning for the hydrogen peroxide, can be estimated in real time.

Referring back to FIG. 1, at block 145 of method 100 a determination is made as to whether there is any residual ozone in the flow of water. Such a determination may be made using an ozone detector. If there is ozone in the flow of water, the method continues to block 150. Otherwise the method proceeds to block 155.

At block 150, additional hydrogen peroxide is added to the flow of water. This may include injecting and mixing an additional hydrogen peroxide solution into the flow of water following the contact basin. Alternatively or additionally, additional hydrogen peroxide may be added upstream to affect future water flows. Such additional hydrogen peroxide may be added before the hydrogen peroxide solution and ozone are mixed into the flow of water. In one embodiment, in which a side flow of water is used for the addition of ozone and hydrogen peroxide, the additional hydrogen peroxide is added to the main flow (e.g., after the side flow has been diverted in one embodiment).

At block 155, the flow of water is directed into a second filtration stage, such as a granulated activated carbon (GAC) filter.

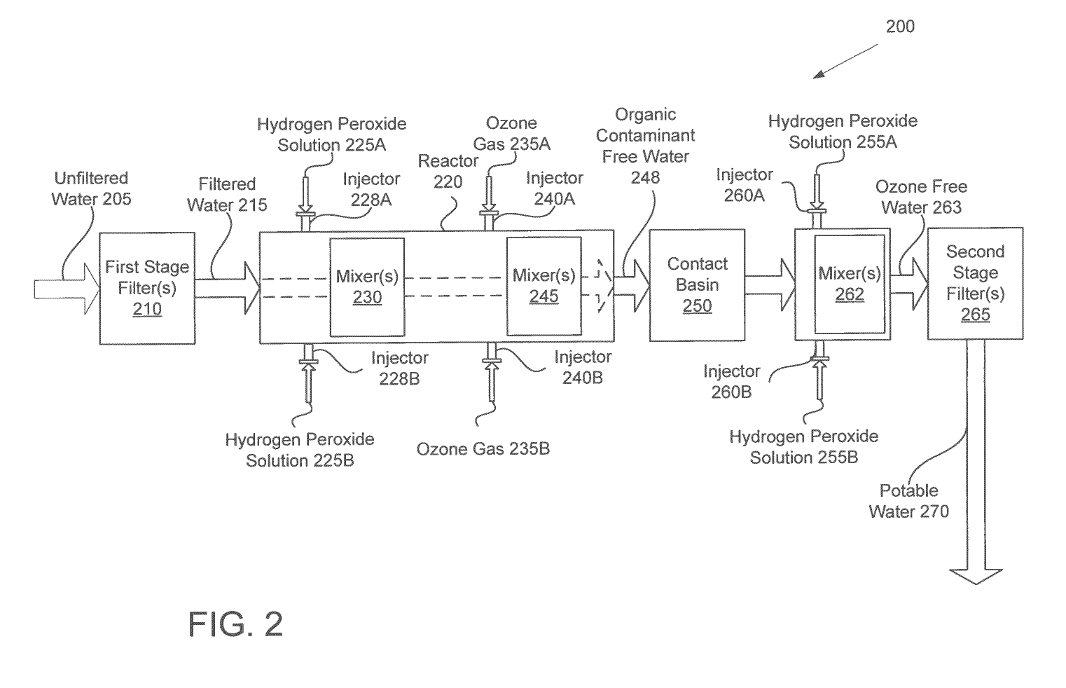

FIG. 2 illustrates one embodiment of a portion of a water treatment plant 200. A flow of unfiltered water 205 enters a first stage filter or filters 210, which outputs a flow of filtered water 215. The first stage filter 210 may be a gravity-type, packed bed filter including GAC, granulated anthracite, sand, or a membrane. Membrane filters may also be pressure type filters that are pumped up to a higher pressure rather than using a gravity flow. The filtered water 215 is input into a reactor 220. In the reactor, a hydrogen peroxide solution 225A, 225B is injected into the flow of water via injectors 228A, 228B. Internal mixers 230 then mix the hydrogen peroxide solution 225A, 225B into the flow of water.

Downstream in the reactor, ozone gas 235A, 235B is injected into the flow of water via additional injectors 240A, 240B. The ozone gas may then me mixed and dissolved into the flow of water by one or more internal mixers 245. The ozone gas and dissolved ozone reacts with hydroperoxide ions to form hydroxyl radicals. These hydroxyl radicals react with organic contaminants in the flow of water by oxidizing the organic contaminants. The flow of water 248 that is output from the reactor 220 may be free of organic contaminants or have an organic contaminant concentration that is below a threshold. The threshold may be, for example, 0.05 ng/L.

The organic contaminant free water 248 may contain residual ozone and/or some residual hydrogen peroxide. Accordingly, the flow of water is directed into a contact basin 250, which slows down the flow of the water and provides time for the ozone to dissipate. The contact basin may hold the water by up to an hour in some embodiments.

An output of the contact basin 250 may be a flow of water that is ozone free. However, if there is residual ozone in the water, then an additional hydrogen peroxide solution 255A, 255B may be injected into the flow of water via injectors 260A, 260B and mixed by mixers 262. This additional hydrogen peroxide solution 255A, 255B may act as an ozone quench and remove the residual ozone from the water.

Ozone free water 263 is input into a second stage filter 265. An output of the second stage filter 265 may be potable water 270.

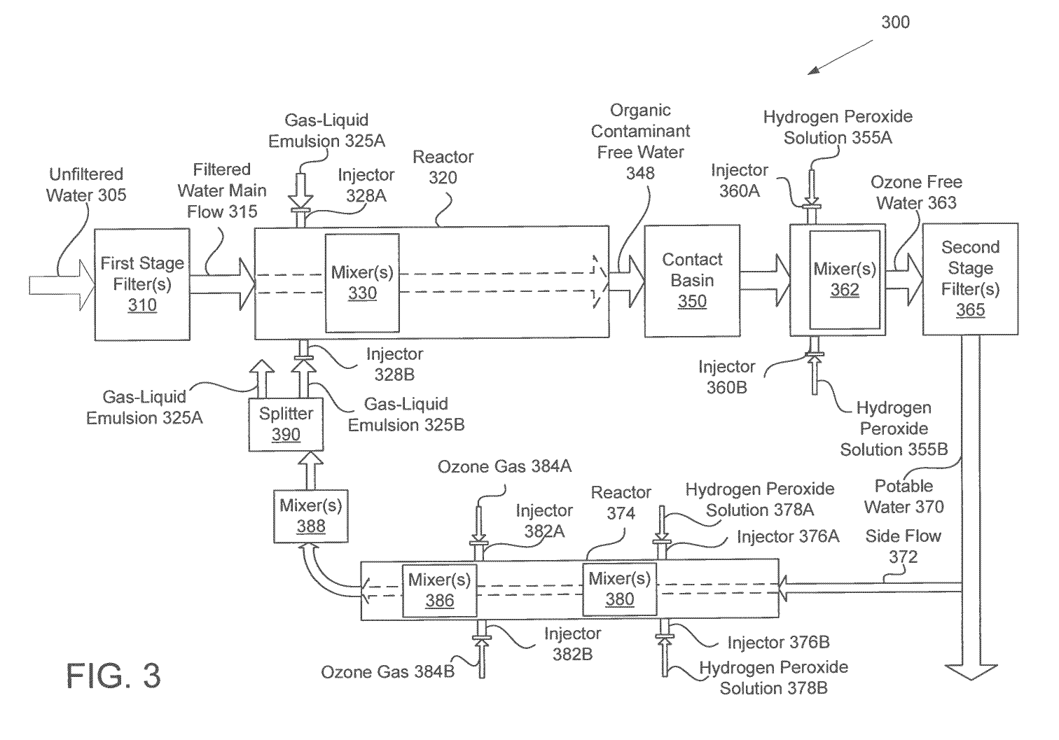

FIG. 3 illustrates another embodiment of a portion of a water treatment plant 300, in which side stream injection of hydrogen peroxide and ozone is implemented. Side-stream injection of ozone using venturi-type eductors and high-velocity jet-injection nozzles results in rapid dissolution of ozone, rapid mixing, high shear and formation of small bubbles, all of which facilitate high rates of ozone mass transfer and ozone-utilization efficiency. An ozone pipeline reactor with tab-style mixers before and after side-stream injection insures uniform velocity profiles and rapid re-mixing and bubble distribution in the shortest possible distance following the side-stream injectors. Untreated water is unable to bypass the injection-mixing section, and this reactor arrangement results in very low pressure drops as well as low coefficients of variation of ozone concentration in the water stream. The combination of Peroxone and this reactor configuration may result in a reduction in required ozone dose exceeding 50% for that in ozone-only applications. This may further result in less required ozone-generating capacity, lower oxygen consumption and smaller contact basins following the reactor, all of which contribute to lower cost of treatment. Existing water-treatment operations using ozone side-stream injection can be easily retrofit using the method and apparatus as described herein.

A flow of unfiltered water 305 enters a first stage filter or filters 310, which outputs a main flow of filtered water 315. The main flow of filtered water 315 is input into a reactor 320. Reactor 320 may be a hydraulically-full reactor, preferably a round conduit or pipe in any spatial orientation but preferably horizontal.

In the reactor, a gas-liquid emulsion 325A, 325B is injected into the main flow of water via injectors 328A, 328B. The gas-liquid emulsion 325A, 325B starts as a side flow of water 372 that is diverted from the main flow of potable water 370 that is output from second stage filters 365. The side flow of water may be approximately 2-5% of the main flow of water 370. The side flow of water is input into a reactor 374.

A hydrogen peroxide solution 378A, 378B is then injected into the side flow of water 372 by injectors 376A, 376B and then mixed by internal mixers 380. The amount of hydrogen peroxide to add may depend on water variables including pH and temperature and desired ozone residual following the reactor or contact basin, if any. To promote hydrogen peroxide dissociation at cold temperatures or low pH, hydroxide ion, typically in the form of aqueous sodium hydroxide, is added to the hydrogen peroxide to condition the hydrogen peroxide solution. The hydroxide ions and peroxide may be premixed before being added to the reactor 374.

In one embodiment of the invention, hydrogen peroxide is added to the side-stream at a mole ratio of 0.5 compared to the ozone dose. In one embodiment of the invention, at low pH or temperature or both, a hydroxide ion (or ions) is added to hydrogen peroxide being added to the side stream. Addition of the hydroxide ion may be limited or controlled to prevent changes in main water pH, the latter of which may be detrimental to subsequent water-treatment processes or water quality. In embodiments of the invention, diluted hydrogen peroxide and diluted hydroxide ions, if any, are blended then mixed using static mixers prior to injection. This hydrogen peroxide/hydroxide solution is then added to the side-stream and adequately mixed before ozone addition to promote ozone dissolution and maximize ozone mass transfer efficiency in the side stream.

Downstream of the mixers 380, injectors 382A, 382B inject ozone gas into the side flow of water 372, and mixers 386 mix the ozone gas into the side flow of water. In one embodiment, injectors 382A, 382B and mixers 386 are combined into an eductor (e.g., a venturi type eductor). The eductor (or injectors and mixers) shred the ozone gas, creating a large number of micro-bubbles. The micro-bubbles have a large surface area compared to their volume, which improves a reaction between the ozone and the hydrogen peroxide. A portion of the ozone gas may also dissolve into the side flow of water. The injection and mixing cause the flow of water to become an approximately uniform gas-liquid emulsion comprising the micro-bubbles. In one embodiment, the flow of water has a coefficient of variation of below 0.02 after the ozone is mixed into the side flow.

An amount of ozone that is injected into the side flow of water may be approximately 10-40 mg/L. The amount of hydrogen peroxide that is injected into the flow of water may be based upon the amount of ozone that is added, in accordance with the equations and charts set forth above. In one embodiment, there is a molar ratio of hydrogen peroxide to ozone of approximately 0.3-0.7.

The ozone gas will naturally re-coalesce and separate from the flow of water shortly after the gas-liquid emulsion is formed. For example, the micro-bubbles may re-coalesce within about 3 feet from the eductor. However, a main reactor 320 that passes the main flow of water 315 may be between 25 and 200 feet away from the reactor 374 in some instances. Additionally, the side flow of water 372 will be re-injected into the main flow of water 315 at multiple locations. Accordingly, mixers 388 re-mix the side flow of water to reform the gas-liquid emulsion containing the micro-bubbles. Shortly after the remixing (e.g., within 2 feet or less of the remixing, within 1 foot or less of the remixing, or immediately after the remixing), a splitter 390 splits the side flow into a first half containing a gas-liquid emulsion 325A and a second half containing a gas-liquid emulsion 325B. These two gas-liquid emulsions may each be approximately uniform, each with a coefficient of variation of below 0.02. The first half may then be injected into the main flow of water at a first location in the main reactor 320, and the second half may be injected into a second location in the main reactor 320 that is approximately diametrically opposed to the first location.

The micro-bubbles in the gas-liquid emulsions 325A, 325B again re-coalesce, and the ozone gas again separates from the water. Accordingly, injectors 328A, 328B remix the split side flows back into the gas-liquid emulsions 325A, 325B before the gas-liquid emulsions are injected back into the main flow of water 325 in the reactor 320. The injectors may be high-velocity jet-injection nozzles that provide rapid mixing, high shear and re-formation of the micro-bubbles. In one embodiment, each injector 328A, 328B includes a collection of injectors that have some physical separation. A configuration and placement of these collections of injectors 328A, 328B may be designed to maximize mixing of the side stream of water back into the main stream of water.

In one embodiment, injectors 328A, 328B include 1-4, opposed and slightly offset side-stream injector arrays or sets consisting of 2 nozzles each, Mazzei® model MTM or equivalent, depending on the required ozone dose. The injector arrays may be followed again by 1-2 arrays of similar tab mixers (mixers 330) to ensure good mixing of the side stream- and main water flows. Mixer arrays may be designed to achieve a coefficient of variation in bubble or chemical concentration less than 0.02 (2%) to ensure effective performance. In one embodiment, Injector nozzles 328A, 328B are designed to achieve an exit velocity of 25-35 feet/second to provide shear and subsequently sub-micron gas bubbles and a coefficient of variation in bubble or chemical concentration less than 0.05 (5%) to ensure effective performance. Very low coefficients of variation are preferred in some embodiments.

Since the side flow of water is 2-5% of the main flow of water, the concentrations of both hydrogen peroxide and ozone become more dilute with mixing into the main flow of water. The concentration of ozone with reference to the main flow of water may be 0.2-2.0 mg/L in some embodiments.

Mixers 330 may mix the gas-liquid emulsion 325A, 325B into the main flow of water 315. The mixers 330 may include 1-2 arrays of inlet tab mixers, Kenics® model HEV or equivalent, depending on the characteristics of the upstream flow configuration and velocity. The inlet mixers 330 may be followed by 1-2 hydraulic diameters of undisturbed flow. In one embodiment, a coefficient of variation for the main flow of water is below 0.05 or below 0.02 after the side flow of water has been re-injected and mixed back into the main flow of water. The hydroxyl radicals that were formed in the side stream of water will react with organic contaminants in the main flow of water to remove those contaminants to produce organic contaminant free water 348.

The organic contaminant free water 348 may contain residual ozone and/or some residual hydrogen peroxide. Accordingly, the flow of water is directed into a contact basin 350, which slows down the flow of the water and provides time for the ozone to dissipate. The contact basin 350 may hold the water by up to an hour in some embodiments, and typically holds the water for 15-30 minutes.

An output of the contact basin 350 may be a flow of water that is ozone free. However, if there is residual ozone in the water, then an additional hydrogen peroxide solution 355A, 355B may be injected into the flow of water via injectors 360A, 360B and mixed by mixers 362. This additional hydrogen peroxide solution 355A, 355B may act as an ozone quench and remove the residual ozone from the water.

Ozone free water 363 is input into a second stage filter 365. An output of the second stage filter 365 may be potable water 370. The side flow of water 372 is then diverted from the flow of water 370 output from the second stage filters 365.

An advantage of the configuration shown in FIG. 3 is that the side flow of water contains a minimal amount of organic contaminants, if any. This may significantly reduce an instantaneous ozone demand (IOD) for the side flow of water, which in turn reduces an amount of ozone that may be used to remove contaminants from the main flow of water 315. As mentioned, side-stream flows for ozone injection are typically 2-5% of the total treated-water flow. In the side stream, ozone concentrations may be 20-40 times higher than the applied dose, and the applied ozone concentration is rapidly reduced by instantaneous ozone demand (IOD) which is a function of dissolved organic carbon (DOC). Using final-filtered water for the side-stream flow, as shown in the configuration of FIG. 3, can reduce DOC up to 50%, further reducing IOD and the required ozone dose by similar amounts depending on the initial ozone dose. For example, an IOD for the side flow of water in this configuration may be around 0.1-0.3 mg/L. The above described configuration of FIG. 3 permits the smallest effective reactor dimensions as well as a low pressure drop, the latter of which is useful for retrofitting existing systems.

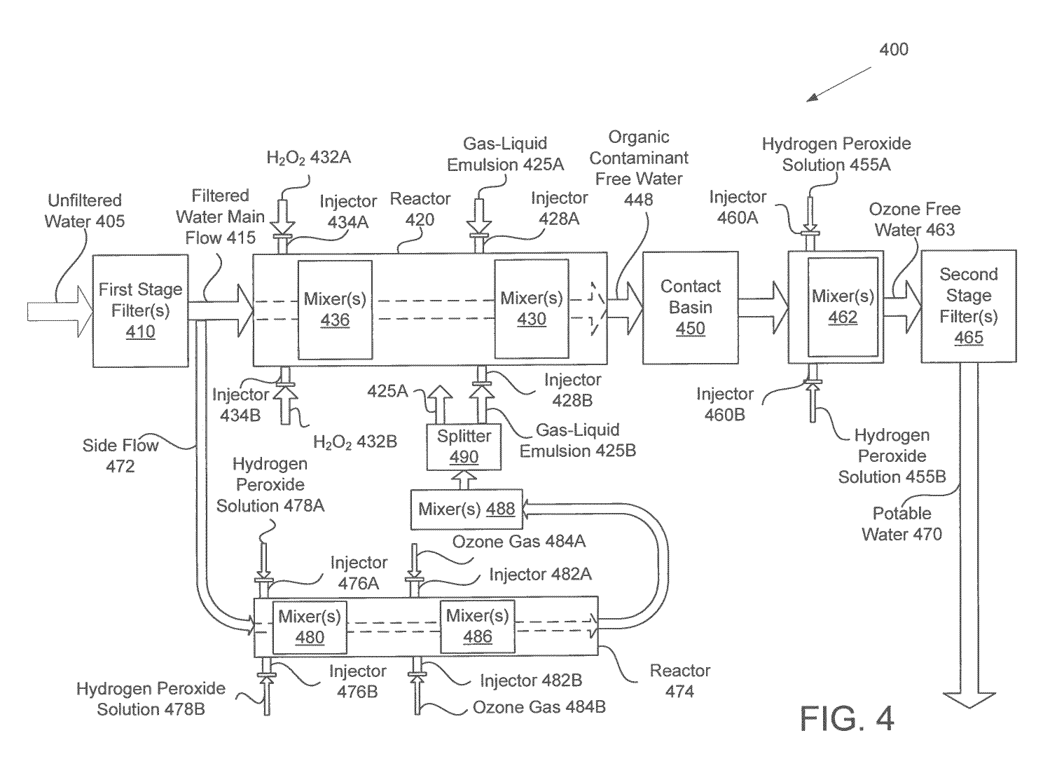

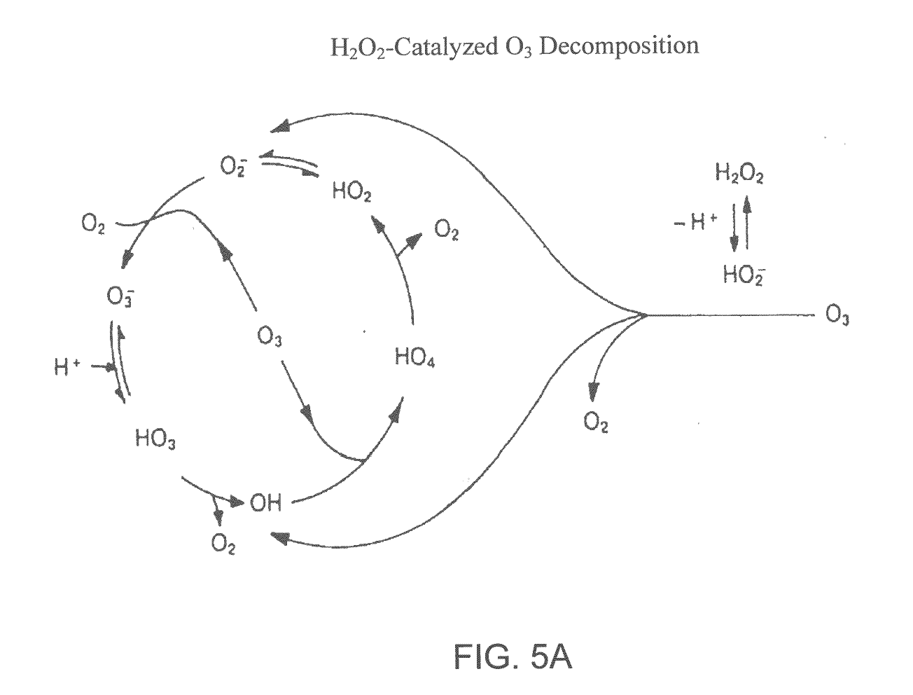

FIG. 4 illustrates yet another embodiment of a portion of a water treatment plant 400 using side stream injection of ozone. The water treatment plant 400 is substantially similar to water treatment plant 300, except that the side flow of water is obtained from a filtered main flow of water 415 at the inlet to a reactor 420. A flow of unfiltered water 405 enters a first stage filter or filters 410, which outputs a main flow of filtered water 415. A side flow 472 of 2-5% of the main flow of water 415 is diverted from the main flow.

The main flow of filtered water 415 is input into the reactor 420. Reactor 420 may be a hydraulically-full reactor, preferably a round conduit or pipe in any spatial orientation but preferably horizontal. Hydrogen peroxide 432A, 432B may be injected into the main flow of water 415 in the reactor by injectors 434A, 434B as a pre-quench for ozone that will later be added. In one embodiment, 2-3 mg/L of hydrogen peroxide is added as a pre-quench. The main flow of water 415 may then be mixed by mixers 436 to integrate the hydrogen peroxide into the water.

The side flow 472 is directed into a side reactor 474. A hydrogen peroxide solution 478A, 478B is then injected into the side flow of water 472 by injectors 476A, 476B and then mixed by internal mixers 480. Downstream of the mixers 480, injectors 482A, 482B inject ozone gas 484A, 484B into the side flow of water 472, and mixers 486 mix the ozone gas into the side flow of water to form a gas-liquid emulsion that includes many micro-bubbles. Reaction of ozone is precipitated by the ozone first diffusing to the gas-liquid interface. Diffusion time is directly proportional to path length. By forming smaller micro-bubbles, the path length from gas to liquid phase is reduced as is diffusion time. Shredding of the bulk ozone gas into micro-bubbles is achieved by shear forces associated with high pressure drops such as those found in venturis or mechanical or static mixing devices. Formation and retention of micro-bubbles has a high impact on effective mass transfer.

Once at the gas interface, the ozone absorbs into the water. Absorption is increased by high concentration of ozone or high pressure in the gas or by low concentration of ozone in the aqueous phase. The latter is achieved by reacting the ozone with hydroperoxide ions to form the hydroxyl radicals at the interface. Thus, the absorption process is enhanced by first premixing the hydroxide ion and hydrogen peroxide (preconditioning) to promote dissociation of hydrogen peroxide. In one embodiment, injectors 482A, 482B and mixers 486 are combined into an eductor (e.g., a venturi type eductor). An IOD that is exhibited for the side flow of water in the configuration of FIG. 4 may be around 0.2-0.6 mg/L in some embodiments.

Mixers 488 re-mix the side flow of water to reform the gas-liquid emulsion containing the micro-bubbles. Mixers 488 may be static mixers that re-shred the ozone gas phase to form the micro-bubbles and the uniform gas-liquid emulsion. After the remixing, a splitter 490 splits the side flow into a first half containing a gas-liquid emulsion 425A and a second half containing a gas-liquid emulsion 425B. The emulsion may be immediately split at the outlet of the mixer 488 to insure equal flow and composition in each nozzle. These two gas-liquid emulsions may each be approximately uniform, each with a coefficient of variation of below 0.02. The first half may then be injected into the main flow of water at a first location in the main reactor 420 by injector 428A, and the second half may be injected into a second location in the main reactor 420 that is approximately diametrically opposed to the first location by injector 428B. Injectors 328A, 328B may remix the split side flows back into the gas-liquid emulsions 325A, 325B before the gas-liquid emulsions are injected back into the main flow of water 325 in the reactor 320.

Mixers 430 may mix the gas-liquid emulsion 425A, 425B into the main flow of water 415. The inlet mixers 430 may be followed by 1-2 hydraulic diameters of undisturbed flow. In one embodiment, a coefficient of variation for the main flow of water is below 0.05 or below 0.02 after the side flow of water has been re-injected and mixed back into the main flow of water. The hydroxyl radicals that were formed in the side stream of water will react with organic contaminants in the main flow of water to remove those contaminants to produce organic contaminant free water 448.

The organic contaminant free water 448 may contain residual ozone and/or some residual hydrogen peroxide. Accordingly, the flow of water is directed into a contact basin 450, which slows down the flow of the water and provides time for the ozone to dissipate. The hydrogen peroxide added to the main flow of water as a pre-quench may quench remaining ozone in the flow of water.

An output of the contact basin 450 may be a flow of water that is ozone free. However, if there is still residual ozone in the water, then an additional hydrogen peroxide solution 455A, 455B may be injected as a post-quench into the flow of water via injectors 460A, 460B and mixed by mixers 462. A dose of around 1-2 mg/L of hydrogen peroxide may be added as a post-quenching agent.

Ozone free water 463 is input into a second stage filter 465. An output of the second stage filter 465 may be potable water 470. Note that any residual hydrogen peroxide in the main flow of water may act to regenerate the filtering capability of the second stage filter 465, such as if the second stage filter is a granulated activated carbon (GAC) filter. This is due to the hydrogen peroxide being an oxidant, and decomposition of such an oxidant on a GAC filter effectively regenerates the GAC by destroying contaminants that have adsorbed onto the surface of the GAC.

In alternative embodiments of the invention, any hydrogen peroxide required above a dose mole ratio of 0.5 is added to the inlet to the reactor by injectors 434A, 434B.

It is to be understood that the above description is intended to be illustrative, and not restrictive. Moreover, where the terms about or approximately are used herein, these terms mean a given value plus or minus 10%. Many other embodiments will be apparent upon reading and understanding the above description. Although embodiments of the present invention have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method of water treatment comprising:
mixing a hydrogen peroxide solution into a flow of water;
mixing and dissolving ozone into the flow of water subsequent to mixing the hydrogen peroxide solution into the flow of water, wherein:
at least a portion of the hydrogen peroxide solution dissociates into hydroperoxide ions at a dissociation rate;
the hydroperoxide ions react with the ozone to form hydroxyl radicals; and
the hydroxyl radicals react with organic contaminants in the flow of water to remove the organic contaminants; and
directing the flow of water into a contact basin after mixing the ozone gas into the flow of water.

2. The method of claim 1, wherein approximately 0.2-2.0 mg/L of ozone is mixed into the flow of water, and wherein there is a molar ratio of hydrogen peroxide to ozone of approximately 0.3-0.7.

3. The method of claim 1, further comprising:
conditioning the hydrogen peroxide solution by mixing a water-soluble hydroxide salt into the hydrogen peroxide solution.

4. The method of claim 3, wherein the hydroxide salt comprises at least one of sodium hydroxide, potassium hydroxide or calcium hydroxide.

5. The method of claim 4, wherein approximately 0.1-0.4 mg/L of the hydroxide salt is mixed into the hydrogen peroxide solution in relation to the volume of the flow of water.

6. The method of claim 3, wherein conditioning the hydrogen peroxide solution further comprises at least one of diluting the hydrogen peroxide solution with water or heating the hydrogen peroxide solution.

7. The method of claim 1, wherein the flow of water comprises a side flow of water that has been diverted from a main flow of water, the method further comprising:
injecting and mixing the side flow of water back into the main flow of water after mixing the ozone into the side flow of water, wherein the hydroxyl radicals in the side flow of water react with additional organic contaminants in the main flow of water to remove the additional organic contaminants.

8. The method of claim 7, wherein the side flow of water comprises 2-5% of the main flow of water.

9. The method of claim 7, wherein 2-40 mg/L of ozone is mixed into the side flow of water, and wherein the ozone is diluted to 0.2-2 mg/L when the side flow of water is mixed into the main flow of water.

10. The method of claim 7, wherein the side flow of water is diverted from the main flow of water at an up stream output of a filter, and wherein an instantaneous ozone demand (IOD) of the side flow of water is between approximately 0.2-0.6 mg/L of ozone.

11. The method of claim 7, wherein the side flow of water is diverted from the main flow of water at a downstream output of a filter which may be of granulated activated carbon, and wherein an instantaneous ozone demand (IOD) of the side flow of water is approximately one-half of that for unfiltered water or 0.1-0.3 mg/L of ozone.

12. The method of claim 7, further comprising:
conditioning the hydrogen peroxide solution by adding a water-soluble hydroxide salt, wherein the conditioned hydrogen peroxide solution causes a first pH of the side flow of water to increase, but a second pH of the main flow of water is unchanged after the injection of the side flow of water back into the main flow of water.

13. The method of claim 7, further comprising:
mixing approximately 2-3 mg/L of additional hydrogen peroxide into the main flow of water upstream of a location at which the side flow of water is injected back into the main flow of water.

14. The method of claim 7, further comprising:
re-mixing the side flow of water after the ozone is mixed into the side flow of water to form an approximately uniform gas-liquid emulsion comprising a plurality of micro-bubbles; and
dividing the approximately uniform gas-liquid emulsion into a first half and a second half, wherein the first half is injected into the main flow of water at a first location and the second half is injected into the main flow of water at a second location that is approximately diametrically opposed to the first position.

15. The method of claim 7, wherein a coefficient of variation for the main flow of water is below 0.05 after injecting the side flow of water back into the main flow of water.

16. The method of claim 1, wherein the concentration of ozone has a coefficient of variation of below 0.02 after mixing the ozone gas into the flow of water.

17. The method of claim 1, further comprising:
mixing additional hydrogen peroxide into the flow of water after the flow of water exits the contact basin to remove residual ozone from the flow of water.

18. The method of claim 1, wherein the ozone comprises an ozone gas and wherein mixing the ozone gas into the flow of water comprises adding the ozone gas to the flow of water using an eductor that shreds the ozone gas into a plurality of micro-bubbles and mixes the plurality of micro-bubbles with the flow of water to form an approximately uniform gas-liquid emulsion.

19. A water treatment plant comprising:
a first filtration stage to filter a main flow of water;
a diverter, downstream of the first filtration stage, to divert approximately 2-5% of the main flow of water into a side stream of water;
an injector to inject a hydrogen peroxide solution into the side stream of water;
an eductor, downstream of the injector, to mix ozone into the side stream of water, wherein at least a portion of the hydrogen peroxide solution dissociates into hydroperoxide ions at a dissociation rate and the hydroperoxide ions react with the ozone gas to form hydroxyl radicals;
a plurality of injectors, downstream of the eductor, to inject the side flow of water back into the main flow of water, wherein the hydroxyl radicals react with organic contaminants in the main flow of water to remove the organic contaminants; and
a contact basin, downstream of the plurality of injectors, to facilitate a decomposition of residual ozone in the main flow of water.

20. The water treatment plant of claim 18, wherein approximately 0.2-2.0 mg/L of ozone is mixed into the flow of water, wherein there is a molar ratio of hydrogen peroxide to ozone of approximately 0.3-0.7, and wherein the hydrogen peroxide solution comprises a water-soluble hydroxide salt.
